(19) United States
(12) Patent Application Publication
(10) Pub. No.: US 2012/0019370 A1
(43) Pub. Date: Jan. 26, 2012

(54) DEVICES AND METHODS FOR PROVIDING WIRELESS COMMAND AND CONTROL TO ELECTRONIC DEVICES

(76) Inventors: Sergei Y. Mironichev, Moscow (RU); Christopher D. Mechling, San Diego, CA (US)

(21) Appl. No.: 13/009,206

(22) Filed: Jan. 19, 2011

Related U.S. Application Data
(60) Provisional application No. 61/296,269, filed on Jan. 19, 2010.

(51) Int. Cl. G05B 11/01

(52) U.S. Cl. 340/12.5

(57) ABSTRACT

A device/system and method for providing remote wireless control to electronic devices such as a tactical flashlight or an electronic night vision scope are disclosed herein. In a preferred embodiment, a smart battery is employed that uses a battery sized external housing, but however replaces a power cell with wireless electronics. Next, an existing battery in the electronic device is replaced with battery sized housing with wireless electronics. A similar device is disclosed herein that replaces a typical end cap of an electronics device and is essentially retrofitted with wireless electronics and replaced to the device where such replacement is attainable.

### PRIORITY CLAIM

This patent application contains subject matter claiming benefit of the priority date of U.S. Prov. Pat. App. Ser. No. 61/296,269 filed on Jan. 19, 2010 entitled SMART BATTERY; additionally this patent application contains subject matter claiming benefit of the priority date of U.S. patent application Ser. No. 12/537,111 filed on Aug. 6, 2009, entitled LIGHT CONTROL DEVICE, which contains subject matter claiming benefit of international patent application No. PCT/RU2008/000508 filed on Aug. 7, 2008; additionally this patent application contains subject matter claiming benefit of the priority date of international patent application No. PCT/RU2009/000075, filed on Feb. 19, 2009 entitled SYSTEM FOR REMOTELY CONTROLLING SIGHTS AND TARGET DESIGNATORS; accordingly, the entire contents of these patent applications are hereby expressly incorporated by reference.

### BACKGROUND OF THE INVENTION

1. Field of the Invention

The present invention relates generally to wireless remote command and control of battery powered electronic devices. More particularly, in a preferred embodiment, the present invention pertains to an electronic receiver device that is sized like a standard AA battery, and methods for providing remote control capability to battery powered devices.

2. Description of the Art

Wireless remote control of electronic devices may be desirable in many situations. One such situation involves tactical or combat scenarios. In these instances, any measurable tactical advantage is welcome in something that may be a life or death situation.

An example of a problem in a tactical environment involves a night vision scope typically mounted to a weapon. Trouble may arise when frequent manual activation/deactivation of a night vision scope becomes tedious when operating in the dark. FIG. 1 herein illustrates a prior art night vision scope as discussed herein.

Without any remote control of the night vision scope, the marksman will have to shift his hands out of firing position and therefore result in momentary loss of steady aim and control of a weapon. Moreover, frequent activation/deactivation may be required as a user will not want to needlessly expense battery power. All this would be occurring in a dark environment. Heretofore, even control by wire solutions have been developed to alleviate this; however in a control by wire design, the wire has to be routed through a rifle handle and therefore results in a more expensive and complication solution.

In light of the above, it is an object of the present invention to provide an electronic component to a device that gives it wireless remote control capability. Further, it is an object of the present invention to provide a solution that is particularly suitable to battery powered devices. It is further an object of the present invention to provide a solution that is has wide ranging applicability.

### BRIEF SUMMARY OF THE INVENTION

The present invention specifically addresses and alleviates the above mentioned deficiencies associated with the prior art. More particularly, the present invention, in a first aspect is a method for providing remote wireless command and control to an electronic device comprising the steps of: providing a receiver integrated circuit; configuring receiver integrated circuit to a housing, the housing in the shape of an existing battery type; replacing an existing battery of the electronic device with the housing configured with the receiver integrated circuit, the existing battery the same as the existing battery type; and providing a remote control device in electronic communication with the receiver integrated circuit, the remote control device together with the receiver integrated circuit providing wireless command and control to the electronic device.

The method herein additionally in this aspect is further characterized wherein the receiver integrated circuit further comprises programmable electronics. Also, the remote control device herein is additionally characterized as having a first remote control button and a second remote control button, wherein the first remote control button serves to activate or deactivate the electronic device, and wherein the second remote control button selects a electronic device mode, wherein the electronic device mode is changed by momentarily clicking the second remote control button, and wherein an additional electronic device feature is adjusted by pressing and holding the second remote control button. The invention in this aspect may be further characterized wherein the existing electronic device is a night vision scope, and further wherein the existing battery type is a AA-battery.

In another aspect, the invention may be characterized as a method for providing remote wireless command and control to an electronic device comprising: providing a receiver integrated circuit; configuring the receiver integrated circuit to a housing, the housing in the shape of an existing electronic device end cap; replacing an existing end cap of the electronic device with the housing configured with the receiver integrated circuit, the existing end cap the same as the existing end cap type; and providing a remote control device in electronic communication with the receiver integrated circuit, the remote control device together with the receiver integrated circuit providing wireless command and control to the electronic device. More specifically, the receiver integrated circuit further has programmable electronics. Also in this invention aspect, the existing electronic device is a tactical flashlight.

In still another aspect, the invention may be characterized as a system for providing remote control capability to an existing electronic device comprising: a remote control module (smart battery), the remote control module comprising: a housing, the housing in the shape of an existing battery type; and a receiver integrated circuit, the receiver integrated circuit providing wireless command and control to the electronic device; and a remote control device for sending control signals to the remote control module.

Also according to a preferred system of the present invention, a first remote control button is provided as well as a second remote control button, wherein the first remote control button serves to activate or deactivate the electronic device, and wherein the second remote control button selects a electronic device mode, wherein the electronic device mode is changed by momentarily clicking the second remote control button, and wherein an additional electronic device feature is adjusted by pressing and holding the second remote control button. The remote control device is additionally characterized as comprising shrink wrap plastic forming an outer protective layer thereof.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective illustration of a prior art night vision scope of the present invention showing a battery compartment configured to receive two AA size batteries;

FIG. 2A is a perspective view of a preferred embodiment of the present invention;

FIG. 2B is a profile view thereof;

FIG. 2C is a perspective view of a remote control device of the present invention showing approximate scale;

FIG. 3 is a perspective illustration of an end cap device of the present invention with a tactical flashlight configured for remote control capability; and

FIG. 4 is a schematical illustration showing a basic setup of a end cap or battery housing embodiment of the present invention.

### DETAILED DESCRIPTION OF PREFERRED EMBODIMENTS

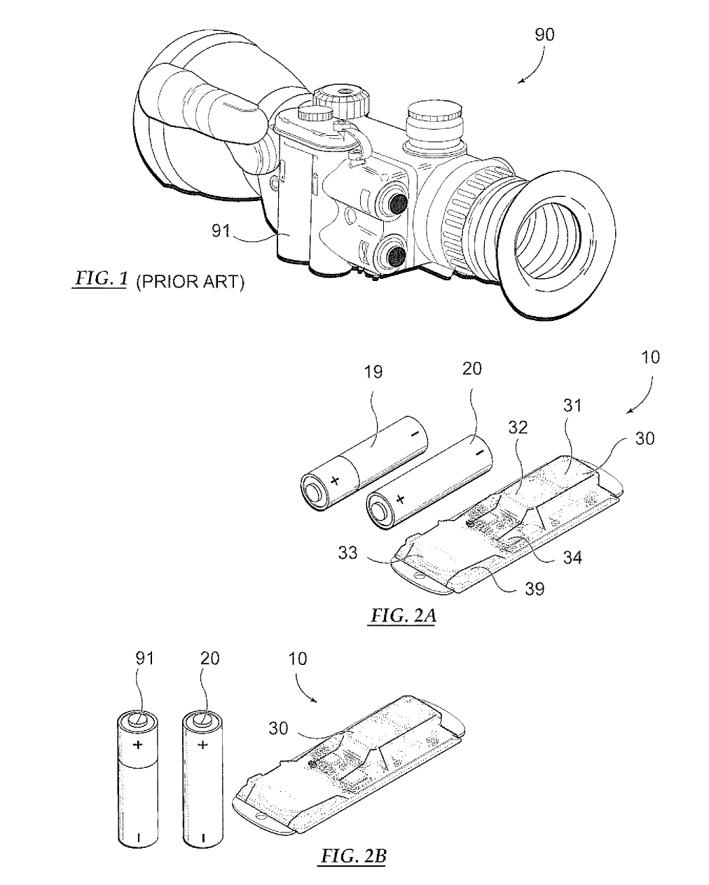

With regard to FIG. 1, a prior art night vision scope 90 is illustrated and is desired to be controlled remotely. Since the device has optics and illumination features controlled electronically, the device 90 includes two AA size battery compartments 91. As stated herein, it is desired to transform this existing device into a wireless remote-controlled enabled device 90 very easily and relatively inexpensively.

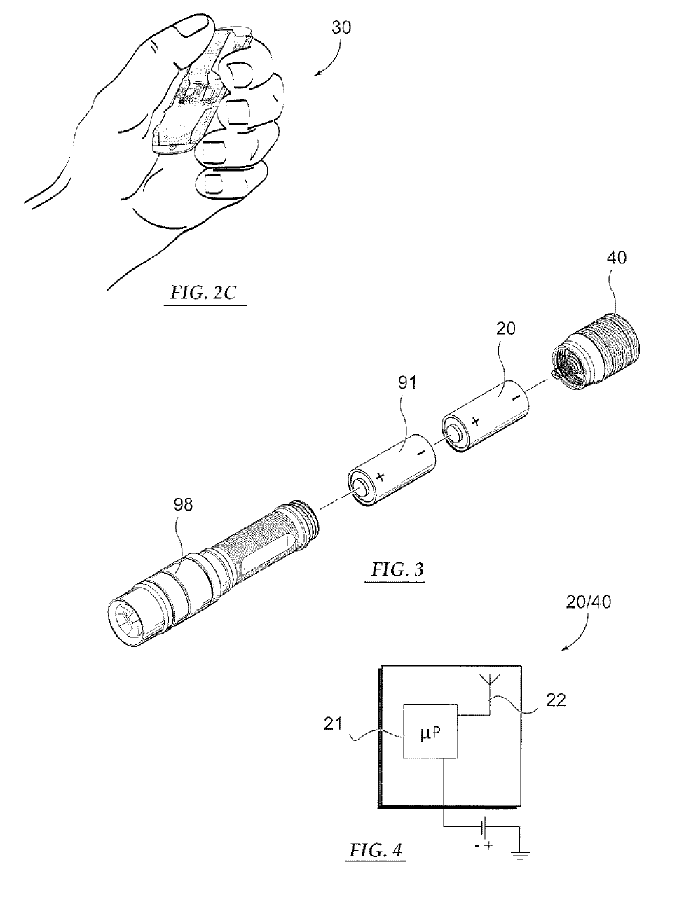

With regard to FIG. 2A, a perspective illustration of a remote control system 10 to include a smart battery 20 of the present invention is shown. Also illustrated are a remote controller 30 and a AA size battery 91, preferably a lithium type. The smart battery 20, or remote control module 20, as termed herein, is not actually a battery 91, but rather a device that can be switched with a typical AA size battery 91 to give the electronic device wireless remote control capability. FIG. 2B provides an additional illustration of the preferred system 10 herein.

In the preferred embodiment, the present invention generally comprises a cylindrical body 20 having first and second ends, the first end further comprising a positive terminal and the second end further comprising a negative terminal. The device further comprises an antenna 22, and a receiver chip 21 (FIG. 4) configured to receive low power, short range (7 meters) RF transmission, wherein the device is generally shaped like an AA size battery 91. It is further contemplated that the invention could be used for other sized batteries not limited to AA size where remote control is desired relatively easily and where an unnecessary battery 91 can be swapped out. As an example, the invention concept could be applicable to a portable compact disc player that typically uses D size batteries 91.

The remote control device, also shown in FIG. 2B, generally comprises a battery 33, a transmitter chip 34 capable of low power, short range, RF transmission, and a on/off actuator 31 together with a mode control button 32. More particularly, a first remote control button 31 serves to activate or deactivate the electronic device 90, 98. Additionally, a second remote control button 32 selects an electronic device 90, 98 mode. Further, the electronic device 90, 98 mode is changed by momentarily clicking the second remote control button 32. Also according to the invention 10, an additional electronic device 90, 98 feature is adjusted by pressing and holding the second remote control button 32. The remote control 30 and module 20 could also comprise additional more complicated electronics. The remote control device 30 further comprises shrink wrap water-proofing 39. Also in a preferred embodiment, the remote control 30 is powered by a CR2032 lithium battery 33 lasting through five (5) thousand cycles. FIG. 2C provides an additional illustration of a remote control device of the present invention.

FIG. 3 presents an alternative embodiment 40 wherein, the wireless electronics 21 are built into an end cap 40 device of a tactical flashlight 98. Therein 40, the previous end cap is replaced with one 40 of the present invention. Also as before, the original end cap can remain while a smart battery remote control module 20 can be used to provide remote control capability. With regard to FIG. 4, a receiver 21 that consumes little power could be employed or alternatively an integrated microprocessor 21 and receiver chip could be employed.

Another aspect of the present invention is that the smart battery 20 will have a unique electronic address as to eliminate any sharing of components. This may be accomplished by encoding a particular device with a 64 bit identifier and transmitting said identifier using a phase shift keying modulated signal. Also in a preferred embodiment, the other battery 91 actually providing power to the electronic device is a lithium battery (ER14505M). An additional feature built into the electronics 21 of the smart battery is that in case of remote control failure, the electronic device 90, 98 will switch back to manual mode. In other words, the smart battery 20 will deactivate remote control.

Yet another feature built into the electronics 21 of the smart battery 20 of the present invention is that it will help save power in the other (or others) battery 91 by manually switching off the electronic device after 10 minutes of operation. This is preferred in a night vision scope 90 application but may not be desired in other applications; and in that event, this feature is omitted.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Devices and Methods for Providing Wireless Command and Control as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A method for providing remote wireless command and control to an electronic device comprising:
providing a receiver integrated circuit;
configuring receiver integrated circuit to a housing, the housing in the shape of an existing battery type;
replacing an existing battery of the electronic device with the housing configured with the receiver integrated circuit, the existing battery the same as the existing battery type; and
providing a remote control device in electronic communication with the receiver integrated circuit, the remote control device together with the receiver integrated circuit providing wireless command and control to the electronic device.

2. The method for providing remote wireless command and control to an electronic device of claim 1 further wherein the receiver integrated circuit further comprises programmable electronics.

3. The method for providing remote wireless command and control to an electronic device of claim 1, the remote control device comprising a first remote control button and a second remote control button, wherein the first remote control button serves to activate or deactivate the electronic device, and wherein the second remote control button selects a electronic device mode, wherein the electronic device mode is changed by momentarily clicking the second remote control button, and wherein an additional electronic device feature is adjusted by pressing and holding the second remote control button.

4. The method for providing remote wireless command and control to an electronic device of claim 1 wherein the existing electronic device is a night vision scope.

5. The method for providing remote wireless command and control to an electronic device of claim 1, wherein the existing battery type is a AA-battery.

6. A method for providing remote wireless command and control to an electronic device comprising:
providing a receiver integrated circuit;
configuring the receiver integrated circuit to a housing, the housing in the shape of an existing electronic device end cap;
replacing an existing end cap of the electronic device with the housing configured with the receiver integrated circuit, the existing end cap the same as the existing end cap type; and
providing a remote control device in electronic communication with the receiver integrated circuit, the remote control device together with the receiver integrated circuit providing wireless command and control to the electronic device.

7. The method for providing remote wireless command and control to an electronic device of claim 6 further wherein the receiver integrated circuit further comprises programmable electronics.

8. The method for providing remote wireless command and control to an electronic device of claim 6, the remote control device comprising a first remote control button and a second remote control button, wherein the first remote control button serves to activate or deactivate the electronic device, and wherein the second remote control button selects a electronic device mode, wherein the electronic device mode is changed by momentarily clicking the second remote control button, and wherein an additional electronic device feature is adjusted by pressing and holding the second remote control button.

9. The method for providing remote wireless command and control to an electronic device of claim 6, wherein the existing electronic device is a tactical flashlight.

10. A system for providing remote control capability to an existing electronic device comprising:
a remote control module, the remote control module comprising:
a housing, the housing in the shape of an existing battery type; and
a receiver integrated circuit, the receiver integrated circuit providing wireless command and control to the electronic device; and
a remote control device for sending control signals to the remote control module.

11. The system for providing remote control capability to an existing electronic device of claim 10, the remote control device comprising;
a first remote control button; and
a second remote control button, wherein the first remote control button serves to activate or deactivate the electronic device, and wherein the second remote control button selects a electronic device mode, wherein the electronic device mode is changed by momentarily clicking the second remote control button, and wherein an additional electronic device feature is adjusted by pressing and holding the second remote control button.

12. The system for providing remote control capability to an existing electronic device of claim 10, the remote control device further comprising shrink wrap plastic forming an outer protective layer thereof.
